(19) United States
(12) Patent Application Publication
(10) Pub. No.: US 2007/0218236 A1
(43) Pub. Date: Sep. 20, 2007

(54) Re-sealable multi-ply in-mold label

(76) Inventors: Donald P. Klein, Dell Rapids, SD (US); Robert E. Baum, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/384,577

(22) Filed: Mar. 20, 2006

(51) Int. Cl. B32B 33/00

(52) U.S. Cl. 428/40.1

(57) ABSTRACT

A re-sealable two-ply in-mold label having a base ply with temperature activated adhesive on its bottom surface and a re-sealable top ply adhered to its upper surface. Two zones of different adhesion intersecure the two plies. A permanent adhesive zone permanently intersecures a margin portion of the two plies to prevent them from being fully separated from one another. A releasable adhesive zone releasably intersecures the remaining portions of the plies. Also disclosed is a method for applying the label to an object including placing the label in a mold, molding an article within the mold thereby activating the adhesive, and removing the article with the label adhered thereto from the mold.

### BACKGROUND OF THE INVENTION

The present invention relates to labels and labeling, and more particularly to in-mold labels and labeling.

In-mold labels and labeling are well known. Such labels are adhered to an article, such as a bottle, during the molding of the article. The label is placed within the cavity of a mold before molding, and the label adheres to the surface of the article during molding.

A typical application is in the production of blow-molded containers. A preprinted label with heat activated adhesive is placed against the surface of the mold cavity and held by vacuum ports in the mold. The mold is closed, and the plastic blank is heated and inflated within the mold. The hot plastic presses against the label, activating the adhesive and causing the label to adhere to the outer surface of the newly molded container. The mold is opened and the labeled container is ejected from the mold. In-mold labels may be furnished as a stack of precut discrete labels or as a continuous web of adjacent labels joined edge to edge and subsequently cut and applied. In-mold labels are disclosed in U.S. Pat. No. 5,344,305 to McKillip.

Expanded content labels (ECLs) suitable for in-mold use are disclosed in U.S. Pat. Nos. 6,508,902 and 6,422,605 to Lind. The disclosed ECLs includes a booklet, leaflet, or other multi-page device, which includes information such as instructions, product warnings, or ingredients. The ECL further includes a base layer having a heat activated adhesive to enable application of the ECL in an in-mold process. Usually, an overlaminate is included over the booklet/leaflet to prevent inadvertent separation of the booklet/leaflet from the base label. Although these ECLs are effective for applications requiring relatively large amounts of information, they are unnecessarily complex and expensive for other applications.

### SUMMARY OF THE INVENTION

The aforementioned problems are overcome by the present invention comprising a re-sealable multi-ply in-mold label (IML). More specifically, the label includes two plies—a base layer and a re-sealable layer. The base layer includes an adhesive on its bottom surface. The re-sealable layer is secured to the base layer using two areas of adhesive having different adhesive qualities—a permanent adhesive area permanently attaches one margin portion of the re-sealable layer to the base layer and a re-sealable adhesive area releasably attaches the remainder of the re-sealable layer to the base layer.

Printing may be included on any of the suitable surfaces of the label. The disclosed embodiment includes printing on three surfaces—the upper surface of the re-sealable ply, the lower surface of the re-sealable ply, and the upper surface of the base ply.

The present invention enables the label to be capable of including far more information than a single-ply label, while avoiding the complexity and expense of an ECL. The re-sealable ply may be peeled open from the base ply and re-sealed closed to the base ply repeatedly. The current embodiment is a two-ply label, but the invention can be readily extended to labels having three or more plies.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of a re-sealable multi-ply label on a bottle.

FIG. 2 is a perspective view similar to FIG. 1 but showing the re-sealable layer open away from the base layer.

FIG. 3 is a sectional view of the label.

### DESCRIPTION OF THE CURRENT EMBODIMENT

I. General Description

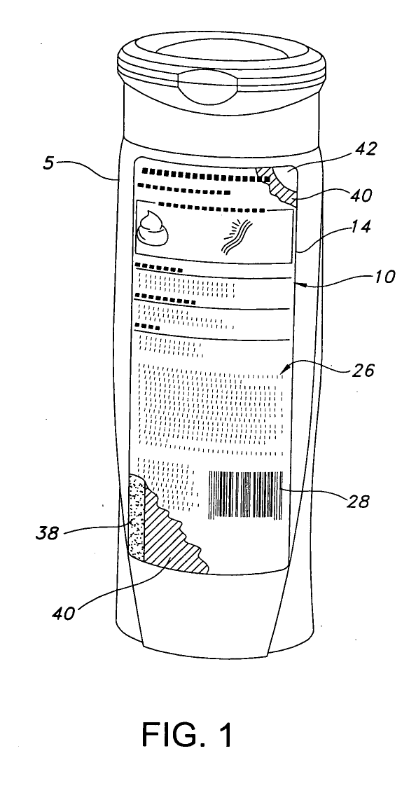

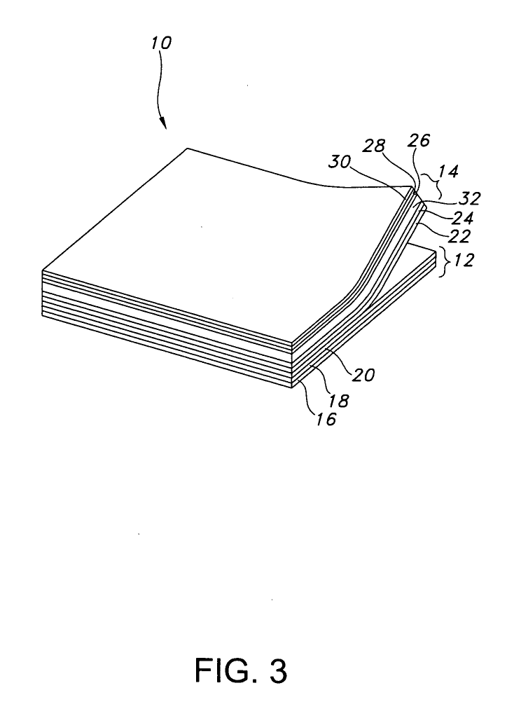

One embodiment of the re-sealable in-mold label (IML) of the present invention is illustrated in FIGS. 1-3, and generally designated 10. The label 10 is applied to an article 5 and includes a base ply 12 and a re-sealable ply 14. The label 10 may be opened by peeling the re-sealable ply 14 from the base ply 12 and closed by re-sealing the re-sealable ply 14 to the base ply 12.

II. Description of the Re-Sealable IML

The described embodiment contemplates a re-sealable two-ply IML. However, the re-sealable IML may contain additional plies. For example, a person of skill in the art would understand how to modify the invention to produce a label having three or more plies.

A. Base Ply

The base ply 12 generally includes a base layer 18, an adhesive 16 on the lower surface of the base layer 18, and a release layer 20 on the upper surface of the base layer 18. The illustrated base layer 18 is a rectangular piece of plastic film. Alternatively, the base layer 18 may be constructed of any other suitable material known to those skilled in the art.

The adhesive layer 16 may be applied to the lower surface of the base layer 18 in a variety of manners and patterns, as will be appreciated by those skilled in the art. In one embodiment, the adhesive layer 14 is made from adhesives that are responsive or activated by heat. Alternatively, the adhesive layer 14 may be made from other suitable adhesives capable of being activated during the molding process.

The release layer 20 cooperates with the adhesive (to be described) on the top ply to control the adhesion between the two plies. The release layer 20 provides a surface to facilitate re-sealing the re-sealable ply 14 to the base ply 12. The release layer 20 may be constructed of any suitable material as will be appreciated by those skilled in the art.

The base ply 12 includes pattern ink or printing 21 visible when the re-sealable IML is in an open state. The printing 21 may be included on the upper surface of the base layer 18 and/or as a separate layer between the release layer 20 and the base layer 18. The contents of the printing 22 may vary. For example, the printing 22 may include instructions, product warnings, ingredients, or identification for or about the article 5. The printing 21 may be applied using any suitable printing techniques, such as UV flexography, letterpress, screen, combination, and/or hot stamping. In an alternative embodiment, the base ply 12 does not include any printing.

B. Re-Sealable Ply

The re-sealable or top ply 14 generally includes layer 32 and adhesive 24 applied to the lower surface of the layer 32. Optionally, the re-sealable ply 14 includes ink layers or printing 22, 26 on both sides of the material 32 and one or more protective coatings 30 on the upper surface of the material 32. The re-sealable ply 14 may include additional, fewer, or differently configured layers.

The material 32 is a plastic film similar in shape and size to the base ply 12. Alternatively, the material 32 may be shaped differently and constructed of other suitable material. Although the illustrated film 32 is substantially opaque, use of clear film is also contemplated. In clear film embodiments, white or other printing may be used to alter the opacity and hide printing on the lower surface of the top ply.

The re-sealable ply 14 overlays the base ply 12 uniformly and closely to avoid the entrapment of any substantial amount of air between the two plies 12, 14.

The adhesive 24 facilitate the re-sealable nature of the label. A portion of the re-sealable ply 14 is permanently adhered to the base ply 12 and a portion of the re-sealable ply 14 is re-sealably adhered to the base ply 12. In the illustrated embodiment, the adhesive 24 include a linear zone 38 of permanent adhesion along one edge of the lower surface of the re-sealable ply 14 and a zone 40 of re-sealable or releasable adhesion substantially covering the remaining surface. The re-sealable zone 40 in the current embodiment is pattern printed to control the amount of adhesion and make the re-sealable ply 14 easier to peel away from the base ply 12. In the current embodiment, the same adhesive is pattern printed using techniques know to those skilled in the art to result in the two zones of different adhesion. Alternatively, the two zones could be created using different adhesives. And the degree of adhesion in the two zones can be produced using other techniques known to those skilled in the art.

Optionally, a portion of the re-sealable ply 14, for example a tab or corner 42 in the illustrated embodiment, is devoid of adhesive to facilitate peeling the re-sealable ply 14 from the base ply 12.

In the illustrated embodiment, the re-sealable ply 14 includes pattern ink or printing 26, 28 visible when the re-sealable IML is closed, and printing 22 visible when the re-sealable IML is open. The printings 26, 28 may be included on the upper surface of the material 32 and/or as separate layers between the material 32 and the coating 30. The printing 22 may be included on the lower surface of the material 32, on the adhesives 24, and/or as a separate layer between the material 32 and the adhesives 24.

Similar to the printing 21 on the base ply 12, the content of the printings 22, 26, 28 of the re-sealable ply 14 may vary. The printings 22, 26, 28 of the re-sealable ply 14 may contain similar or different information than the printing 21 on the base ply 12. In one embodiment, each printing 20, 22, 26 contains similar or identical information in a different language. The printings 20, 22, 26, 28 may include graphical and/or textual information. For example, in the illustrated embodiment, the printings 20, 22, 26 include textual information, and the printing 28 includes graphical information in the form of a bar code. The printings 20, 22, 26, 28 may be applied using any suitable print technique as described above in connection with the base ply printing 21.

One or more coatings 30 may covers the upper surface of the film 32 to protect the re-sealable ply 14 and/or the printing 26 from damage. The coating may be constructed of any suitable material known to those skilled in the art.

III. Application and Use of the Re-Sealable IML

In operation, preprinted and adhesive-coated re-sealable labels 10 are provided in roll, magazine, or other suitable forms (not shown) as known in the art. The re-sealable labels 10 may be transferred to the interior of a blow or injection mold (not shown) using techniques and apparatuses known in the art. Once transferred, known molding techniques may be applied to sufficiently adhere the re-sealable IML 10 to the molded article 5. For example, a re-sealable multi-ply IML may be placed in a mold with the molding activated adhesive facing away from the mold. The molding activated adhesive is activated by the molding process causing the re-sealable multi-ply label to be adhered to the article. Once the molding is finished, the molded article with the adhered re-sealable multi-ply label may be removed from the mold. In one embodiment, the re-sealable IML 10 becomes part of the molded article 5 during the molding process.

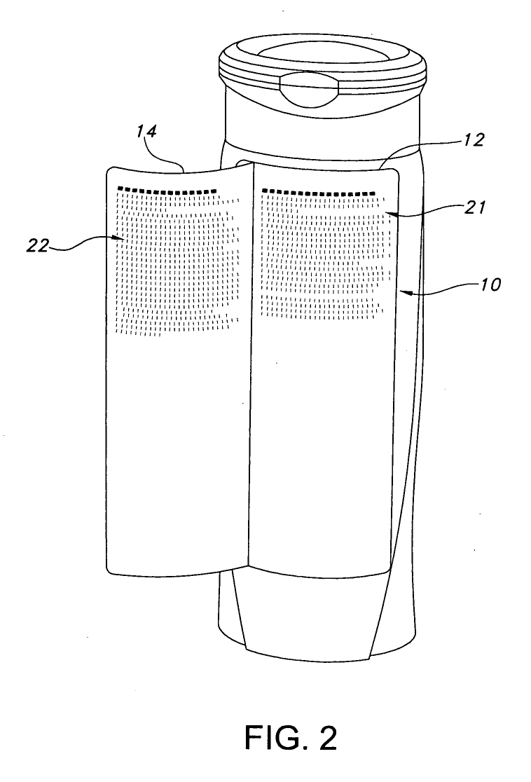

In use, the re-sealable IML 10 may be opened and closed to reveal or hide the information on the inside of the label. FIG. 1 depicts an article 5 with a closed re-sealable two-ply IML and FIG. 2 depicts an article 5 with an open re-sealable two-ply IML.

In a closed state, the re-sealable ply 14 overlays and adheres to the base ply 12. In the illustrated embodiment, the upper surface of the re-sealable ply 14 is the only visible surface in this configuration. More specifically, the lower surface of the re-sealable ply 14 and the upper surface of the base ply 12 are both hidden while the label 10 is closed. In the current embodiment, the connection between the re-sealable ply 14 and the base ply 12 is sufficiently strong to keep the re-sealable ply 14 adhered to the base ply 12 as long as sufficient external separating force is not applied.

The re-sealable ply 14 may be peeled away from the base ply 12 to reconfigure the re-sealable IML into an open state. The re-sealable IML may be peeled open, or opened in any manner which makes viewing information on the lower re-sealable ply 14 surface and/or upper base ply 12 surface convenient. Opening the re-sealable IML does not substantially damage either of the plies or any of the individual layers of the plies. In the illustrated embodiment, sufficient force to peel the re-sealable ply 14 open is substantially insufficient to separate the permanent adhesion between the re-sealable ply 14 and the base ply 12. Instead, the permanent adhesion acts as a hinge to open and close the re-sealable IML.

In the fully open state, as shown in FIG. 2, the re-sealable ply 14 is adhered to the base ply 12 by the permanent adhesive 38. The printing 21 on the upper surface of the base ply 12 and the printing 22 on the lower surface of the re-sealable ply are exposed.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a, ” “an, ” “the ” or “said, ” is not to be construed as limiting the element to the singular.

The embodiments of the invention in which an exclusive property or privilege is claimed are defined as follows:

1. An in-mold label comprising:
a base ply having upper and lower surfaces, said base ply lower surface including an in-mold process activated adhesive;
a re-sealable ply having upper and lower surfaces, said re-sealable ply at least partially overlaying said base ply;
a permanent adhesive zone between said base ply upper surface and said re-sealable ply lower surface, said permanent adhesive zone permanently connecting a first portion of said base ply and a first portion of said re-sealable ply; and
a re-sealable adhesive zone between said base ply upper surface and said re-sealable ply lower surface, said re-sealable adhesive zone re-sealably connecting a second portion of said base ply and a second portion of said re-sealable ply.

2. The in-mold label of claim 1 where a corner of said re-sealable ply lower surface is substantially devoid of adhesive to facilitate peeling open said re-sealable ply.

3. The in-mold label of claim 1 where said permanent adhesive zone is configured as a strip near an edge of said base ply upper surface and said re-sealable ply lower surface, and where said re-sealable adhesive substantially covers a substantial remaining portion of said re-sealable ply lower surface.

4. The in-mold label of claim 1 where said re-sealable adhesive is pattern printed.

5. The in-mold label of claim 1 further comprising:
base ply upper surface printing on said upper surface of said base ply and under said release layer;
re-sealable ply lower surface printing on said re-sealable adhesive on said lower surface of said re-sealable ply; and
re-sealable ply upper surface printing on said re-sealable ply upper surface.

6. The in-mold label of claim 5 where each of said base ply upper surface printing, said re-sealable ply lower surface printing, and said re-sealable ply upper surface printing is in a different language.

7. The in-mold label of claim 1 where said re-sealable ply is substantially opaque.

8. The in-mold label of claim 1 where said re-sealable ply is substantially clear.

9. An in-mold label comprising:
a base ply having upper and lower surfaces; and
a re-sealable ply having upper and lower surfaces, a first portion of said re-sealable ply lower surface permanently adhered to said base ply upper surface, a second portion of said re-sealable ply lower surface re-sealably adhered to said base ply upper surface.

10. The in-mold label of claim 9 where a corner of said re-sealable ply lower surface is substantially devoid of adhesive to facilitate peeling open said re-sealable ply.

11. The in-mold label of claim 9 where said first portion is configured as a strip near an edge of said base ply and said re-sealable ply.

12. The in-mold label of claim 9 further comprising:
base ply upper surface printing on said base ply upper surface;
re-sealable ply lower surface printing on said re-sealable ply lower surface; and
re-sealable ply upper surface printing on said re-sealable ply upper surface.

13. The in-mold label of claim 12 where each of said base ply upper surface printing, said re-sealable ply lower surface printing, and said re-sealable ply upper surface printing is in a different language.

14. The in-mold label of claim 9 where said re-sealable ply is substantially opaque.

15. The in-mold label of claim 9 where said re-sealable ply is substantially clear.

16. A method for applying a re-sealable multi-ply label in an in-mold labeling process, comprising the steps of:
placing a multi-ply label including a base ply and a re-sealable ply, each having different heat deformation properties, and a molding activated adhesive in a mold with the adhesive facing away from the mold.
molding an article within the mold such that the molding activated adhesive is activated causing the re-sealable multi-ply label to be adhered to the article; and
removing the molded article with the adhered re-sealable multi-ply label from the mold.

17. The method of claim 1 wherein said molding comprises one of blow molding or injection molding.
